(19) United States
(12) Patent Application Publication
(10) Pub. No.: US 2022/0051052 A1
(43) Pub. Date: Feb. 17, 2022

(54) GROUND EXTRACTION METHOD FOR 3D POINT CLOUDS OF OUTDOOR SCENES BASED ON GAUSSIAN PROCESS REGRESSION

(71) Applicant: Dalian University of Technology, Dalian (CN)

(72) Inventors: Yi An, Dalian (CN); Wusong Liu, Dalian (CN); Xiusheng Li, Dalian (CN); Jinyu Wang, Dalian (CN); Lei Wang, Dalian (CN)

(21) Appl. No.: 17/513,876

(22) Filed: Oct. 28, 2021

Related U.S. Application Data
(63) Continuation-in-part of application No. PCT/CN2021/071055, filed on Jan. 11, 2021.

(30) Foreign Application Priority Data
Jun. 8, 2020 (CN) 202010510160.6

(51) Int. Cl. G06K 9/62; G06T 17/00; G01S 17/89

(52) U.S. Cl. CPC G06K 9/6232; G06K 9/6269; G06K 9/628; G01S 17/89; G06K 9/6298; G06T 17/005; G06K 9/6223

(57) ABSTRACT

A ground extraction method for 3D point clouds of outdoor scenes based on Gaussian process regression, including: (1) obtaining the 3D point cloud of an outdoor scene, (2) building the neighborhood of the 3D point cloud, (3) calculating the covariance matrices and normal vectors of the 3D point cloud, (4) classifying the 3D point cloud according to its neighborhood shape, (5) extracting the initial ground Gₛ, (6) segmenting the initial ground, (7) 2D Gaussian process regression, (8) finding the neighborhood N_{LG}_{ₖ} of each ground fragment LGₖ, and (9) extracting the final ground Gₑ.

### CROSS-REFERENCE TO RELATED APPLICATIONS

This application is a continuation-in-part of International Patent Application No PCT/CN2021/071055 with an international filing date of Jan. 11, 2021, designating the United States, now pending, and further claims priority benefits to Chinese Patent Application No. 202010510160.6, filed Jun. 8, 2020. The contents of all of these specifications are incorporated herein by reference.

### BACKGROUND OF THE INVENTION

### Field of the Invention

The invention relates to a ground extraction method for 3D point clouds, more specifically, to a ground extraction method for 3D point clouds of outdoor scenes based on Gaussian process regression.

### Description of the Related Art

With the development of 3D laser ranging technology, 3D point clouds are widely used in reverse engineering, industrial inspection, autonomous navigation, and so on. As the basis of the above applications, the 3D point cloud processing technology plays a vital role. In the 3D point cloud processing technology, feature extraction of 3D point clouds is an important technique, especially ground feature extraction of 3D point clouds of outdoor scenes, which plays an important role in segmentation and recognition of outdoor scenes, path planning of mobile robots, and so on.

In the field of autonomous navigation of mobile robots, the ground extraction of 3D point clouds of outdoor scenes is the premise of path planning of mobile robots. A complete ground provides passable areas for mobile robots, improves the passing capacity of mobile robots, and ensures the safety of mobile robots during their moving. In the field of outdoor scene analysis, since outdoor scenes are extremely complex, various objects are involved, such as buildings, trees, vehicles, people, and so on. To facilitate outdoor scene analysis, it is necessary to effectively segment 3D point clouds of outdoor scenes. Since the ground is the background of outdoor scenes, ground extraction contributes to separating the objects on the ground, which facilitates the object segmentation and scene analysis.

Now, the commonly used ground extraction method of 3D point clouds is the random sampling consistency (RANSAC) algorithm, which regards the ground as the largest surface in an outdoor scene. The method has a good performance for the flat and large ground. However, for some complex outdoor scenes, the ground is fragmentary and fluctuant. The method cannot guarantee the integrity and accuracy of ground extraction.

### SUMMARY OF THE INVENTION

In view of the above-described problems, it is one objective of the invention to provide a ground extraction method for 3D point clouds of outdoor scenes based on Gaussian process regression. For an outdoor scene, the method first uses a laser rangefinder to obtain the 3D point cloud of an outdoor scene, which is essentially a set of discrete points in 3D space. Then, through the ground extraction method, the ground point cloud data are accurately and completely extracted from the 3D point cloud of the outdoor scene. The method solves the problem of incomplete and inaccurate ground extraction caused by the factors, such as complex outdoor scenes, fragmentary ground, and fluctuant ground, so as to improve the accuracy and integrity of ground extraction in outdoor scenes. The method has good performance on ground extraction.

To achieve the above objectives, in accordance with one embodiment of the invention, there is provided a ground extraction method of 3D point clouds of outdoor scenes based on Gaussian process regression, which includes the following steps.

Step 1: Obtaining the 3D point cloud of an outdoor scene. The 3D point cloud of an outdoor scene (a set of discrete points) is collected by using a laser rangefinder.

Step 2: Building the neighborhood of the 3D point cloud. The structure tree of the 3D point cloud is constructed by using the KD-tree algorithm. According to the coordinates of the discrete points in the 3D point cloud, the 3D point cloud is divided into different spatial regions. In the process of the neighborhood construction, the spatial address information is used to search the neighboring points. Then, the neighborhood N={pᵢ=(xᵢ, yᵢ, zᵢ)|1≤i≤nₙ} of a given point p=(x,y,z) in the 3D point cloud is built, where pᵢ is a neighboring point of the given point p=(x,y,z), i is the serial number of the neighboring points pᵢ and nₙ is the number of the neighboring points pᵢ.

Step 3: Calculating the covariance matrices and normal vectors of the 3D point cloud. For the given point p=(x,y,z) in the 3D point cloud, its covariance matrix M is constructed by using its neighborhood N={pᵢ=(xᵢ,yᵢ,zᵢ)|1≤i≤nₙ}. Then, the eigenvalues λ₁, λ₂, λ₃ and eigenvectors v₁,v₂,v₃ of the covariance matrix M and the normal vector n of the given point p are computed. This step includes the following substeps:

(a) By using the neighborhood relationship built in step 2, the neighborhood N={pᵢ=(xᵢ,yᵢ,zᵢ)|1≤i≤nₙ} of the given point p=(x,y,z) is built.

(b) The covariance matrix M of the neighborhood N of the given point p is computed as

M=Σᵢ₌₁ⁿ^{ₙ}(pᵢ−p)(pᵢ−p)^{T} (1),

where T is a vector transpose symbol that transposes a column vector to a row vector.

(c) The eigenvalues λ₁, λ₂, λ₃ (λ₁<λ₂<λ₃) and the corresponding eigenvectors v₁, v₂, v₃ of the covariance matrix M is computed.

(d) The normal vector n of the given point p is computed as the eigenvector v₁ corresponding to the minimum eigenvalue λ₁.

(e) For each point in the 3D point cloud, its eigenvalues, eigenvectors, and normal vector are computed by using the substeps (a)-(d).

Step 4: Classifying the 3D point cloud according to its neighborhood shape. The neighborhood shape of the given point p is determined by using the relationship among the eigenvalues λ₁, λ₂, λ₃ of the covariance matrix M of the given point p. The 3D point cloud is divided into three classes, the scattered points Cₚ, the linear points Cₗ, and the surface points Cₛ. This step includes the following substeps:

(a) If λ₁≈λ₂≈λ₃, i.e. λ₃/λ₂≤8 and λ₂/λ₁≤8, the given point p and its neighboring points pᵢ present a scattered shape, and the given point p is categorized as a scattered point.

(b) If λ₁≈λ₂<<λ₃, i.e. λ₃/λ₂>8 and λ₂/λ₁≤8, the given point p and its neighboring points pᵢ present a linear shape, and the given point p is categorized as a linear point.

(c) If λ₁<<λ₂≈λ₃, i.e. λ₃/λ₂≤8 and λ₂/λ₁>8, the given point p and its neighboring points pᵢ present a surface shape, and the given point p is categorized as a surface point.

(d) For each point in the 3D point cloud, the substeps (a)-(c) are performed. Then, the 3D point cloud is divided into three classes, the scattered points Cₚ, the linear points Cₗ, and the surface points Cₛ.

Step 5: Extracting the initial ground Gₛ. For each surface point in the set Cₛ, its normal vector is put on a unit ball S, which is called the normal ball. By using the mean shift algorithm, the normal vectors of the surface points Cₛ are clustered on the normal ball S Then, the surface points are divided into several surface regions Fⱼ. Finally, the initial ground Gₛ is extracted from the surface regions. This step includes the following substeps.

(a) For each surface point in Cₛ, its normal vector is put on a unit ball S, which is called the normal ball. That is, the terminal point of the normal vector is located on the surface of the normal ball S, and the initial point of the normal vector is located at the center of the normal ball S.

(b) The mean shift algorithm is chosen to cluster the normal vectors of the surface points Cₛ on the normal ball S. Then, the normal vectors of the surface points Cₛ are divided into several groups. And, the surface points Cₛ are also divided into several surface regions Fⱼ correspondingly, 1≤j≤m, where j is the serial number of the surface regions and m is the number of the surface regions.

(c) For each surface region, its average elevation h̅ⱼ and average normal vector n̅ⱼ are calculated. If the average elevation h̅ⱼ and average normal vector n̅ⱼ meet the conditions: h̅ⱼ≤0.5 m and −5°≤α̅ⱼ≤+5°, where α̅ⱼ is the included angle between the average normal vector n̅ⱼ and the vertical direction, the surface region Fⱼ is considered as a part of the initial ground Gₛ. This method is applied to each region Fⱼ, and then the initial ground Gₛ is obtained.

Step 6: Segmenting the initial ground. The initial ground point pₜ is the point in the initial ground Gₛ By using the K-means algorithm, the initial ground Gₛ is divided into K ground fragments according to the distance between the initial ground point pₜ and the center point pₖ of each ground fragment. Each ground fragment is denoted by LGₖ={pₖₛ=(xₖₛ,yₖₛ,zₖₛ)|1≤s≤nₖ}, 1≤k≤K, where pₖₛ is the point in the ground fragment LGₖ, k is the serial number of the ground fragments, K is the number of the ground fragments, s is the serial number of the points in the ground fragment LGₖ, and nₖ is the number of the points in the ground fragment LGₖ. This step includes the following substeps:

(a) By using the farthest point sampling method, K points are determinded as the initial center points pₖ of the ground fragments, 1≤k≤K. K is set at the beginning.

(b) The distance between each initial ground point pₜ (1≤t≤nₛ) and the center point pₖ of each ground fragment is calculated, where t is the serial number of the points in the initial ground Gₛ and nₛ is the number of the points in the initial ground Gₛ. Each initial ground point pₜ is assigned to its closest center point of the ground fragment.

(c) When all the initial ground points pₜ are assigned, the center point pₖ of each ground fragment is recalculated according to the points pₖₛ in the ground fragment LGₖ by

$${p}_{k} = \frac{1}{{n}_{k}} {\sum }_{s = 1}^{{n}_{k}} {p}_{k s} , \qquad ( 2 )$$

where pₖ is the new center point of the ground fragment.

(d) The substeps (b)-(c) are repeated until pₖ does not change again. Finally, the points pₖₛ assigned to pₖ are grouped as one ground fragment. The initial ground Gₛ is divided into K ground fragments LGₖ (1≤k≤K).

Step 7: 2D Gaussian process regression. 2D Gaussian process regression is used to build the probabilistic model for each ground fragment LGₖ. The ground fragment LGₖ is used as the training samples to train the 2D Gaussian process regression model. The hyperparameters lₖ, σₖ² and σₙ² of the model are solved by using the conjugate gradient method. This step includes the following substeps:

(a) A discrete function zₖₛ=ƒ_{d}(tₖₛ), tₖₛ=[xₖₛ, yₖₛ]^{T} is defined on the ground fragment LGₖ. The value of the discrete function ƒ_{d}(tₖₛ) at a location tₖₛ represents the random variable in the Gaussian process.

(b) The Gaussian process is specified by its mean function m(tₖₛ) and covariance function k(tₖₛ, tₖₜ), tₖₛ, tₖₜ∈{tₖ₁, tₖ₂, . . . , tₖₙ_{ₖ}} as

$$\{ \begin{matrix}m ( {t}_{k s} ) = ( {f}_{d} ( {t}_{ks} ) ) \\ k ( {t}_{ks} , {t}_{kt} ) = [ ( {f}_{d} ( {t}_{ks} ) - m ( {t}_{ks} ) ) ( {f}_{d} ( {t}_{kt} ) - m ( {t}_{kt} ) ) ]\end{matrix} , \qquad ( 3 )$$

Thus, the Gaussian process can be written as ƒ_{d}/(tₖₛ)˜ [symbol] (m(tₖₛ), k(tₖₛ, tₖₜ)).

(c) In consideration of the noise ε, the discrete function is changed to zₖₛ=ƒ_{d}(tₖₛ)+ε. Assume additive identically distributed independent Gaussian noise ε with the variance σₙ². The joint prior distribution of the observed values zₖ=[zₖ₁,zₖ₂, . . . , zₖₙ_{ₖ}]^{T} is

zₖ˜N(0,K(Tₖ,Tₖ)+σₙ²I) (4),

where Tₖ=[tₖ₁,tₖ₂, . . . ,tₖₙ_{ₖ}] and K(Tₖ,Tₖ)=(kₛₜ) is a nₖ×nₖ covariance matrix of the training inputs Tₖ. The element kₛₜ is used to measure the correlation between tₖₛ and tₖₜ, and kₛₜ is the squared exponential covariance function, which has the following form

$${k}_{st} = {σ}_{k}^{2} exp \{ - \frac{1}{2 {l}_{k}^{2}} {\vert {t}_{k s} - {t}_{kt} \vert}^{2} \} , \qquad ( 5 )$$

where lₖ is the length-scale, σₖ² is the signal variance, and 1≤s, t≤nₖ(s≠t).

(d) The joint prior distribution of the observed values zₖ and the predicted value ƒ_{*} at the test location t_{*}=[x_{*},y_{*}]^{T} is given by

$$[ \begin{matrix}{z}_{k} \\ {f}_{*}\end{matrix} ] ∼ N ( 0 , [ \begin{matrix}K ( {T}_{k} , {T}_{k} ) + {σ}_{n}^{2} I & K ( {T}_{k} , {t}_{*} ) \\ K ( {t}_{*} , {T}_{k} ) & K ( {t}_{*} , {t}_{*} )\end{matrix} ] ) \qquad ( 6 )$$

where K(Tₖ,t_{*})=K(t_{*},Tₖ)^{T} is the nₖ×1 covariance matrix of the training inputs Tₖ and the test input t_{*}, K(t_{*},t_{*}) is the covariance of the test input t_{*}, and I is the nₖ×nₖ unit matrix. Then, the posterior distribution of the predicted value ƒ_{*}, namely the 2D Gaussian process regression model of the ground fragment LGₖ, is given by

ƒ_{*}|Tₖ,zₖ,t_{*}˜N(m(ƒ_{*}),cov(ƒ_{*})) (7),

where

m(ƒ_{*})=K(t_{*},Tₖ)[K(Tₖ,Tₖ)+σₙ²I]⁻¹zₖ (8),

cov(ƒ_{*})=K(t_{*},t_{*})−K(t_{*},Tₖ)[K(Tₖ,Tₖ)+σₙ²I]⁻¹K(Tₖ,t_{*}) (9),

m(ƒ_{*}) and cov(ƒ_{*}) are the mean and variance of ƒ_{*} at the test location t_{*}.

(e) The points in the ground fragment LGₖ are used as the training samples. The negative logarithm likelihood function of the conditional probability of the training samples is established. And, the partial derivatives of the hyperparameters lₖ, σₖ² and σₙ² are calculated. Then, the conjugate gradient method is used to minimize the partial derivatives to obtain the optimal solution of the hyperparameters.

Step 8: Finding the neighborhood N_{LG}_{ₖ} of each ground fragment LGₖ. For each ground fragment LGₖ, the distance between each point pₖₛ (pₖₛ∈LGₖ) in the ground fragment LGₖ and each point pₐ in the 3D point cloud P={pₐ=(xₐ, yₐ, zₐ)|1≤a≤nₐ} of the outdoor scene is computed. If the distance is less than the threshold rₖ, pₐ is regarded as a neighboring point of the ground fragment LGₖ, where a is the serial number of the points in the 3D point cloud P of the outdoor scene and nₐ is the number of the points in the 3D point cloud P of the outdoor scene. This step includes the following substeps.

(a) The neighborhood Nₚ_{ₖₛ}={pₖₛ^{b}|1≤b≤nₖₛ,pₖₛ^{b}∈P,|pₖₛ^{b}−pₖₛ|≤rₖ} of each points pₖₛ in the ground fragment LGₖ is computed, where nₖₛ is the number of the neighboring points of pₖₛ, rₖ=0.25\sqrt{nₖ}dₖ, dₖ=Σₛ₌₁ⁿ^{ₖ}|pₖₛ−p̅ₖₛ|/nₖ, and p̅ₖₛ is the closest point to pₖₛ.

(b) All the neighborhoods Nₚ_{ₖₛ} compose the neighborhood of the ground fragment LGₖ. Let N_{LG}_{ₖ}={\hat{p}_{ks′}=(\hat{x}_{ks′},ŷ_{ks′},\hat{z}_{ks′})|1≤s′≤\hat{n}ₖ}, where \hat{p}_{ks′} is the neighboring point of the ground fragment LGₖ, s′ is the serial number of the neighboring points, and \hat{n}ₖ is the number of the neighboring points.

Step 9: Extracting the final ground Gₑ. The neighborhood of each ground fragment LGₖ is substituted into the 2D Gaussian process regression model of the ground fragment LGₖ. For each point \hat{p}_{ks′}∈N_{LG}_{ₖ}, the predicted mean m(\hat{ƒ}_{ks′}) and variance cov(\hat{ƒ}_{ks′}) at the test location \hat{t}_{ks′}=[\hat{x}_{ks′},ŷ_{ks′}]^{T} are calculated. If they meet the conditions: cov(\hat{ƒ}_{ks′})≤σ̅² and |m(\hat{ƒ}_{ks′})−\hat{z}_{ks′}|/\sqrt{σₖ²+σₙ²}≤d̅, where σ̅²=0.05 is the threshold of the variance and d̅=0.2 is the threshold of the Mahalanobis distance, the point \hat{p}_{ks′} is regarded as a ground point. By using this method for each ground fragment LGₖ to check the points in its neighborhood, the ground points in the neighborhood N_{LG}_{ₖ} of each ground fragment LGₖ is found. Then, the final ground Gₑ is obtained.

The beneficial effect of the invention is a ground extraction method for 3D point clouds of outdoor scenes based on Gaussian process regression, which includes the following steps. (1) obtaining the 3D point cloud of an outdoor scene, (2) building the neighborhood of the 3D point cloud, (3) calculating the covariance matrices and normal vectors of the 3D point cloud, (4) classifying the 3D point cloud according to its neighborhood shape, (5) extracting the initial ground Gₛ, (6) segmenting the initial ground, (7) 2D Gaussian process regression, (8) finding the neighborhood N_{LG}_{ₖ} of each ground fragment LGₖ, and (9) extracting the final ground Gₑ. Compared with the existing methods, the invention adopts the idea of layer-by-layer extraction First, through the eigenvalue analysis of covariance matrices, the whole surface area (the set of surface points Cₛ) in the 3D point cloud of the outdoor scene is extracted. Then, by building the normal ball S of the set of surface points Cₛ and clustering the normal vectors on the normal ball S, the whole surface area (the set of surface points Cₛ) is divided into several surface regions Fⱼ. Through the combination of normal vectors and elevations, the initial ground Gₛ is obtained from surface regions Fⱼ. The K-means clustering algorithm is used to segment the initial ground Gₛ into several more compact ground fragments LGₖ. Finally, the final ground Gₑ is obtained by Gaussian process regression of the ground fragments LGₖ. The idea of layer-by-layer extraction can make the ground extraction of 3D point clouds more complete and accurate. Especially, when the outdoor scene very is complex, the initial ground is divided into several compact ground fragments, the Gaussian process regression is then carried out respectively, and the final ground is obtained by OR operation at last. This contributes to extracting the fragmentary and fluctuant ground. Therefore, the method of the invention effectively solves the problem of incomplete and inaccurate ground extraction caused by the factors, such as complex outdoor scenes, fragmentary ground, and fluctuant ground. The method has good performance on ground extraction.

### BRIEF DESCRIPTION OF THE DRAWINGS

The invention is described hereinbelow with reference to the accompanying drawings, in which:

FIG. 1 is the flow chart of the method of the invention.

FIG. 2 is the 3D point cloud of an outdoor scene.

FIG. 3 is the result of the surface point extraction.

FIG. 4 is the result of the normal ball construction.

FIG. 5 is the result of the normal vector clustering.

FIG. 6 is the result of the initial ground extraction.

FIG. 7 is the result of the initial ground segmentation.

FIG. 8 is a ground fragment and its neighborhood.

FIG. 9 is the result of the final ground extraction.

### DETAILED DESCRIPTION OF THE DRAWINGS

To further illustrate the invention, embodiments detailing a ground extraction method for 3D point clouds are described below. It should be noted that the following embodiments are intended to describe and not to limit the invention.

The invention will be further explained with the figures.

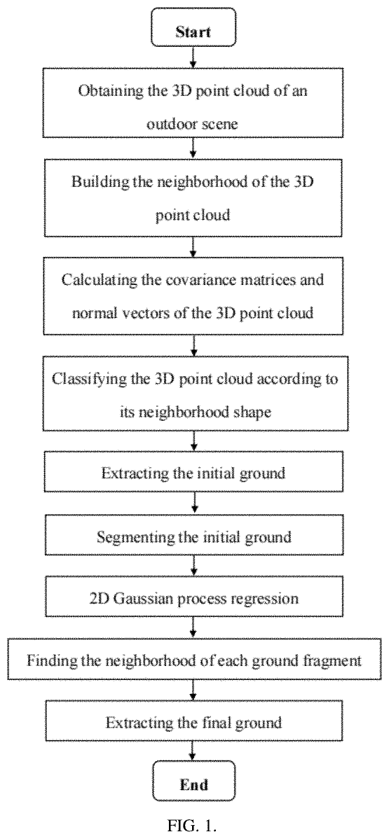

As shown in FIG. 1, a ground extraction method for 3D point clouds of outdoor scenes based on Gaussian process regression. Its characteristics include the following steps:

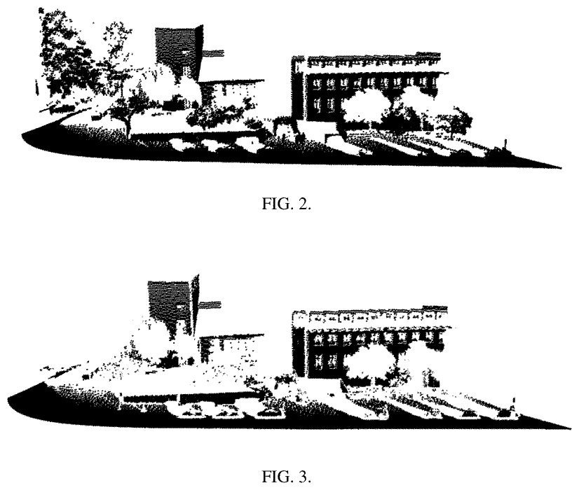

Step 1: Obtaining the 3D point cloud of an outdoor scene. The 3D point cloud of an outdoor scene (a set of discrete points) is collected by using a laser rangefinder. As shown in FIG. 2, the whole outdoor scene consists of about 100000 points, including the ground, trees, grass, buildings, vehicles, people, etc.

Step 2: Building the neighborhood of the 3D point cloud. The structure tree of the 3D point cloud is constructed by using the KD-tree algorithm. According to the coordinates of the discrete points in the 3D point cloud, the 3D point cloud is divided into different spatial regions. In the process of the neighborhood construction, the spatial address information is used to search the neighboring points. Then, the neighborhood N={pᵢ=(xᵢ, yᵢ, zᵢ)|1≤i≤nₙ} of a given point p=(x,y,z) in the 3D point cloud is built, where pᵢ is a neighboring point of the given point p=(x,y,z), i is the serial number of the neighboring points pᵢ and nₙ is the number of the neighboring points pᵢ.

Step 3: Calculating the covariance matrices and normal vectors of the 3D point cloud. For the given point p=(x,y,z) in the 3D point cloud, its covariance matrix M is constructed by using its neighborhood N={pᵢ=(xᵢ, yᵢ,zᵢ)|1≤i≤nₙ}. Then, the eigenvalues Δ₁,λ₂,λ₃ and eigenvectors v₁,v₂,v₃ of the covariance matrix M and the normal vector n of the given point p are computed. This step includes the following substeps:

(a) By using the neighborhood relationship built in step 2, the neighborhood N={pᵢ=(xᵢ,yᵢ,zᵢ)|1≤i≤nₙ} of the given point p=(x,y,z) is built.

(b) The covariance matrix M of the neighborhood N of the given point p is computed as

M=Σᵢ₌₁ⁿ^{ₙ}(pᵢ−p)(pᵢ−p)^{T} (1),

where T is a vector transpose symbol that transposes a column vector to a row vector.

(c) The eigenvalues λ₁, λ₂, λ₃ (λ₁<λ₂<λ₃) and the corresponding eigenvectors v₁, v₂, v₃ of the covariance matrix M is computed.

(d) The normal vector n of the given point p is computed as the eigenvector v₁ corresponding to the minimum eigenvalue λ₁.

(e) For each point in the 3D point cloud, its eigenvalues, eigenvectors, and normal vector are computed by using the substeps (a)-(d).

Step 4: Classifying the 3D point cloud according to its neighborhood shape. The neighborhood shape of the given point p is determined by using the relationship among the eigenvalues λ₁, λ₂, λ₃ of the covariance matrix M of the given point p. The 3D point cloud is divided into three classes: the scattered points Cₚ, the linear points Cₗ, and the surface points Cₛ. This step includes the following substeps:

(a) If λ₁≈λ₂≈λ₃, i.e. λ₃/λ₂≤8 and λ₂/λ₁≤8, the given point p and its neighboring points pᵢ present a scattered shape, and the given point p is categorized as a scattered point.

(b) If λ₁≈λ₂<<λ₃, i.e. λ₃/λ₂>8 and λ₂/λ₁≤8, the given point p and its neighboring points pᵢ present a linear shape, and the given point p is categorized as a linear point.

(c) If λ₁<<λ₂≈λ₃, i.e. λ₃/λ₂≤8 and λ₂/λ₁>8, the given point p and its neighboring points pᵢ present a surface shape, and the given point p is categorized as a surface point.

(d) For each point in the 3D point cloud, the substeps (a)-(c) are performed. Then, the 3D point cloud is divided into three classes, the scattered points Cₚ, the linear points Cₗ, and the surface points Cₛ. The extraction result of the surface points Cₛ of the outdoor scene is shown in FIG. 3.

Step 5: Extracting the initial ground Gₛ For each surface point in the set Cₛ, its normal vector is put on a unit ball S, which is called the normal ball. By using the mean shift algorithm, the normal vectors of the surface points Cₛ are clustered on the normal ball S. Then, the surface points are divided into several surface regions Fⱼ. Finally, the initial ground Gₛ is extracted from the surface regions. This step includes the following substeps:

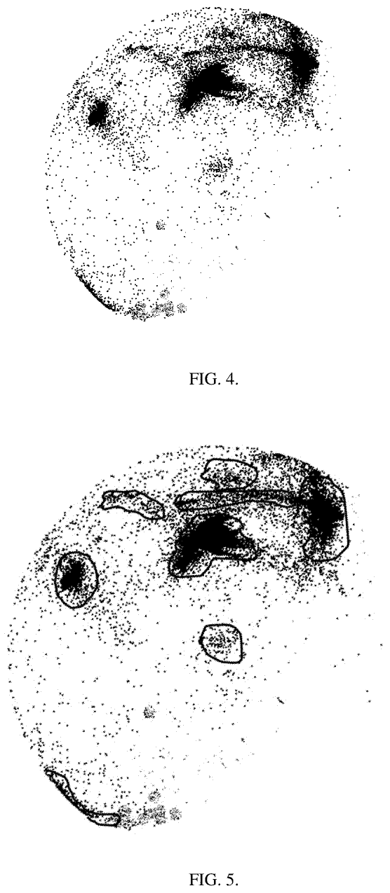

(a) For each surface point in Cₛ, its normal vector is put on a unit ball S, which is called the normal ball. As shown in FIG. 4, the terminal point of the normal vector is located on the surface of the normal ball S, and the initial point of the normal vector is located at the center of the normal ball S.

(b) The mean shift algorithm is chosen to cluster the normal vectors of the surface points Cₛ on the normal ball S. As shown in FIG. 5, the normal vectors of the surface points Cₛ are divided into several groups. And, the surface points Cₛ are also divided into several surface regions Fⱼ correspondingly, 1≤j≤m, where j is the serial number of the surface regions and m is the number of the surface regions.

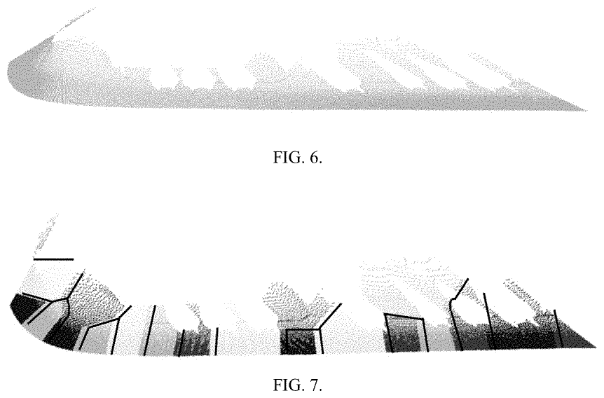

(c) For each surface region, its average elevation h̅ⱼ and average normal vector n̅ⱼ are calculated. If the average elevation h̅ⱼ and average normal vector n̅ⱼ meet the conditions. h̅ⱼ≤0.5m and −5°≤α̅ⱼ≤+5°, where α̅ⱼ is the included angle between the average normal vector n̅ⱼ and the vertical direction, the surface region Fⱼ is considered as a part of the initial ground Gₛ. As shown in FIG. 6, this method is applied to each region Fⱼ, and then the initial ground Gₛ is obtained.

Step 6: Segmenting the initial ground. The initial ground point pₜ is the point in the initial ground Gₛ. By using the K-means algorithm, the initial ground Gₛ is divided into K ground fragments according to the distance between the initial ground point pₜ and the center point pₖ of each ground fragment. Each ground fragment is denoted by LGₖ={pₖₛ=(xₖₛ,yₖₛ,zₖₛ)|1≤s≤nₖ}, 1≤k≤K, where pₖₛ is the point in the ground fragment LGₖ, k is the serial number of the ground fragments, K is the number of the ground fragments, s is the serial number of the points in the ground fragment LGₖ, and nₖ is the number of the points in the ground fragment LGₖ. This step includes the following substeps:

(a) By using the farthest point sampling method, K points are determined as the initial center points pₖ of the ground fragments, 1≤k≤K. K is set at the beginning.

(b) The distance between each initial ground point pₜ (1≤t≤nₛ) and the center point pₖ of each ground fragment is calculated, where t is the serial number of the points in the initial ground Gₛ and nₛ is the number of the points in the initial ground Gₛ. Each initial ground point pₜ is assigned to its closest center point of the ground fragment.

(c) When all the initial ground points pₜ are assigned, the center point pₖ of each ground fragment is recalculated according to the points pₖₛ in the ground fragment LGₖ by

$${p}_{k} = \frac{1}{{n}_{k}} {\sum }_{s = 1}^{{n}_{k}} {p}_{ks} , \qquad ( 2 )$$

where pₖ is the new center point of the ground fragment.

(d) The substeps (b)-(c) are repeated until pₖ does not change again. Finally, the points pₖ assigned to pₖ are grouped as one ground fragment. The initial ground Gₛ is divided into K ground fragments LGₖ(1≤k≤K), as shown in FIG. 7.

Step 7: 2D Gaussian process regression. 2D Gaussian process regression is used to build the probabilistic model for each ground fragment LGₖ. The ground fragment LGₖ is used as the training samples to train the 2D Gaussian process regression model. The hyperparameters lₖ, σₖ² and σₙ² of the model are solved by using the conjugate gradient method. This step includes the following substeps:

(a) A discrete function zₖₛ=ƒ_{d}(tₖₛ), tₖₛ=[xₖₛ, yₖₛ]^{T} is defined on the ground fragment LGₖ. The value of the discrete function ƒ_{d}(tₖₛ) at a location tₖₛ represents the random variable in the Gaussian process.

(b) The Gaussian process is specified by its mean function m(tₖₛ) and covariance function k(tₖₛ, tₖₜ), tₖₛ, tₖₜ∈{tₖ₁, tₖ₂, . . . , tₖₙ_{ₖ}} as

$$\{ \begin{matrix}m ( {t}_{k s} ) = ( {f}_{d} ( {t}_{ks} ) ) \\ k ( {t}_{ks} , {t}_{kt} ) = [ ( {f}_{d} ( {t}_{ks} ) - m ( {t}_{ks} ) ) ( {f}_{d} ( {t}_{kt} ) - m ( {t}_{kt} ) ) ]\end{matrix} . \qquad ( 3 )$$

Thus, the Gaussian process can be written as

ƒ_{d}(tₖₛ)˜ [symbol] (m(tₖₛ),k(tₖₛ,tₖₜ)).

(c) In consideration of the noise ε, the discrete function is changed to zₖₛ=ƒ_{d}(tₖₛ)+ε. Assume additive identically distributed independent Gaussian noise ε with the variance σₙ². The joint prior distribution of the observed values zₖ=[zₖ₁, zₖ₂, . . . , zₖₙ_{ₖ}]^{T} is

zₖ˜N(0,K(Tₖ,Tₖ)+σₙ²I) (4),

where Tₖ=[tₖ₁, tₖ₂, . . . , tₖₙ_{ₖ}] and K(Tₖ,Tₖ)=(kₛₜ) is a nₖ×nₖ covariance matrix of the training inputs Tₖ. The element kₛₜ is used to measure the correlation between tₖₛ and tₖₜ, and kₛₜ is the squared exponential covariance function, which has the following form

$${k}_{st} = {σ}_{k}^{2} exp \{ - \frac{1}{2 {l}_{k}^{2}} {\vert {t}_{k s} - {t}_{kt} \vert}^{2} \} , \qquad ( 5 )$$

where lₖ is the length-scale, σₖ² of is the signal variance, and 1≤s, t≤nₖ(s≠t).

(d) The joint prior distribution of the observed values zₖ and the predicted value ƒ_{*} at the test location t_{*}=[x_{*},y_{*}]^{T} is given by

$$[ \begin{matrix}{z}_{k} \\ {f}_{*}\end{matrix} ] ∼ N ( 0 , [ \begin{matrix}K ( {T}_{k} , {T}_{k} ) + {σ}_{n}^{2} I & K ( {T}_{k} , {t}_{*} ) \\ K ( {t}_{*} , {T}_{k} ) & K ( {t}_{*} , {t}_{*} )\end{matrix} ] ) , \qquad ( 6 )$$

where K(Tₖ,t_{*})=K(t_{*},Tₖ)^{T} is the nₖ×1 covariance matrix of the training inputs Tₖ and the test input t_{*}, K(t_{*},t_{*}) is the covariance of the test input t_{*}, and I is the nₖ×nₖ unit matrix. Then, the posterior distribution of the predicted value ƒ_{*}, namely the 2D Gaussian process regression model of the ground fragment LGₖ, is given by

ƒ_{*}|Tₖ,zₖ,t_{*}˜N(m(ƒ_{*}),cov(ƒ_{*})) (7),

where

m(ƒ_{*})=K(t_{*},Tₖ)[K(Tₖ,Tₖ)+σₙ²I]⁻¹zₖ (8),

cov(ƒ_{*})=K(t_{*},t_{*})−K(t_{*},Tₖ)[K(Tₖ,Tₖ)+σₙ²I]⁻¹K(Tₖ,t_{*}) (9),

m(ƒ_{*}) and cov(ƒ_{*}) are the mean and variance of ƒ_{*} at the test location t_{*}.

(e) The points in the ground fragment LGₖ are used as the training samples. The negative logarithm likelihood function of the conditional probability of the training samples is established And, the partial derivatives of the hyperparameters lₖ, σₖ² and σₙ² are calculated. Then, the conjugate gradient method is used to minimize the partial derivatives to obtain the optimal solution of the hyperparameters.

Step 8: Finding the neighborhood N_{LG}_{ₖ} of each ground fragment LGₖ. For each ground fragment LGₖ, the distance between each point pₖₛ (pₖₛ ∈LGₖ) in the ground fragment LGₖ and each point pₐ in the 3D point cloud P={pₐ=(xₐ, yₐ, zₐ)|1≤a≤nₐ} of the outdoor scene is computed. If the distance is less than the threshold rₖ, pₐ is regarded as a neighboring point of the ground fragment LGₖ, where a is the serial number of the points in the 3D point cloud P of the outdoor scene and nₐ is the number of the points in the 3D point cloud P of the outdoor scene. This step includes the following substeps.

(a) The neighborhood Nₚ_{ₖₛ}={pₖₛ^{b}|1≤b≤nₖₛ, pₖₛ^{b}∈P,|pₖₛ^{b}−pₖₛ|≤rₖ} of each points pₖₛ in the ground fragment LGₖ is computed, where nₖₛ is the number of the neighboring points of pₖₛ, rₖ=0.25\sqrt{nₖ}dₖ, dₖ=Σₛ₌₁ⁿ^{ₖ}|pₖₛ−p̅ₖₛ|/nₖ, and p̅ₖₛ is the closest point to pₖₛ.

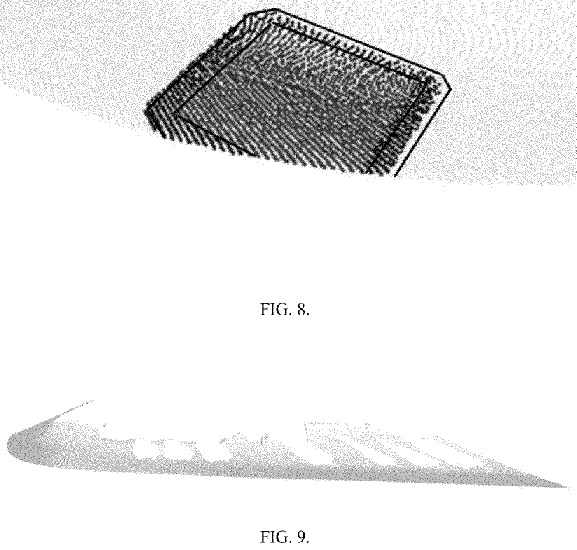

(b) All the neighborhoods Nₚ_{ₖₛ} compose the neighborhood N_{LG}_{ₖ} of the ground fragment LGₖ. Let N_{LG}_{ₖ}={\hat{p}_{ks′}=(\hat{x}_{ks′},ŷ_{ks′},\hat{z}_{ks′})|1≤s′≤\hat{n}ₖ}, where \hat{p}_{ks′} is the neighboring point of the ground fragment LGₖ, s′ is the serial number of the neighboring points, and \hat{n}ₖ is the number of the neighboring points. The neighborhood N_{LG}_{ₖ} of the ground fragment LGₖ is shown in FIG. 8.

Step 9: Extracting the final ground Gₑ The neighborhood N_{LG}_{ₖ} of each ground fragment LGₖ is substituted into the 2D Gaussian process regression model of the ground fragment LGₖ. For each point \hat{p}_{ks′}∈N_{LG}_{ₖ}, the predicted mean m(\hat{ƒ}_{ks′}) and variance cov(\hat{ƒ}_{ks′}) at the test location \hat{t}_{ks′}=[\hat{x}_{ks′},ŷ_{ks′}]^{T} are calculated. If they meet the conditions: cov(\hat{ƒ}_{ks′})≤σ̅² and |m(\hat{ƒ}_{ks′})−\hat{z}_{ks′}|/\sqrt{σₖ²+σₙ²}≤d̅, where σ̅²=0.05 is the threshold of the variance and 3=0.2 is the threshold of the Mahalanobis distance, the point \hat{p}_{ks′} is regarded as a ground point. By using this method for each ground fragment LGₖ to check the points in its neighborhood, the ground points in the neighborhood N_{LG}_{ₖ} of each ground fragment LGₖ is found. Then, the final ground Gₑ is obtained as shown in FIG. 9.

Advantages of the ground extraction method for 3D point clouds of outdoor scenes based on Gaussian process regression according to the invention are described as follows. Without any function assumption, such as linear function and quadratic function, Gaussian process regression can well approximate the unknown function by considering the correlation between the function value and the given observation value, even in the case of the abrupt change. This feature facilitates the flexible handling of the irregular ground. The invention uses the idea of layer-by-layer extraction and Gaussian process regression to accurately and completely extract the ground from 3D point clouds of outdoor scenes, which effectively solves the problems of incomplete and inaccurate ground extraction caused by the factors, such as complex outdoor scene, fragmentary ground, and fluctuant ground. The method has good performance on ground extraction.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention

What is claimed is:

1. A ground extraction method for 3D point clouds of outdoor scenes based on Gaussian process regression, comprising the following steps:
step 1: obtaining a 3D point cloud of an outdoor scene by using a laser rangefinder, wherein the 3D point cloud of the outdoor scene is a set of discrete points;
step 2: building a neighborhood of the 3D point cloud, comprising: constructing a structure tree of the 3D point cloud by using a KD-tree algorithm, dividing the 3D point cloud into different spatial regions according to coordinates of the discrete points in the 3D point cloud, using spatial address information to search neighboring points in the process of the neighborhood construction, and building the neighborhood N={pᵢ=(xᵢ,yᵢ,zᵢ)|1≤i≤nₙ} of a given point p=(x,y,z) in the 3D point cloud, wherein pᵢ is a neighboring point of the given point p=(x,y,z), i is the serial number of the neighboring points pᵢ, and nₙ is the number of the neighboring points pᵢ;
step 3: calculating covariance matrices and normal vectors of the 3D point cloud, wherein for the given point p=(x,y,z) in the 3D point cloud, a covariance matrix M is constructed by using its neighborhood N={pᵢ=(xᵢ,yᵢ,zᵢ)|1≤i≤nₙ}, and eigenvalues λ₁,λ₂,λ₃ and eigenvectors v₁,v₂,v₃ of the covariance matrix M and a normal vector n of the given point p are computed; and step 3 comprises the following substeps:
(a) building the neighborhood N={pᵢ=(xᵢ,yᵢ,zᵢ)|1≤i≤nₙ} of the given point p=(x,y,z) by using the neighborhood relationship built in step 2;
(b) computing the covariance matrix M of the neighborhood N of the given point p as
M=Σᵢ₌₁ⁿ^{ₙ}(pᵢ−p)(pᵢ−p)^{T} (1),
wherein T is a vector transpose symbol that transposes a column vector to a row vector;
(c) computing the eigenvalues λ₁, λ₂, λ₃ (λ₁<λ₂<λ₃) and the corresponding eigenvectors v₁, v₂, v₃ of the covariance matrix M,
(d) computing the normal vector n of the given point p as the eigenvector v₁ corresponding to the minimum eigenvalue λ₁; and
(e) for each point in the 3D point cloud, repeating the substeps (a)-(d), whereby computing eigenvalues, eigenvectors, and normal vector for each point in the 3D point cloud;
step 4: classifying the 3D point cloud according to its neighborhood shape; wherein, a neighborhood shape of the given point p is determined by using the relationship among the eigenvalues λ₁, λ₂, λ₃ of the covariance matrix M of the given point p; the 3D point cloud is divided into three classes: the scattered points Cₚ, the linear points Cₗ, and the surface points Cₛ; and step 4) comprises the following substeps:
(a) categorizing the given point p as a scattered point if λ₁≈λ₂≈λ₃, i.e. λ₃/λ₂≤8 and λ₂/λ₁≤8, and the given point p and its neighboring points pᵢ present a scattered shape;
(b) categorizing the given point p as a linear point if λ₁≈λ₂<<λ₃, i.e. λ₃/λ₂>8 and λ₂/λ₁≤8, and the given point p and its neighboring points pᵢ present a linear shape,
(c) categorizing the given point pas a surface point if λ₁<<λ₂≈λ₃, i.e. λ₃/λ₂≤8 and λ₂/λ₁>8, and the given point p and its neighboring points pᵢ present a surface shape; and
(d) repeating the substeps (a)-(c) for each point in the 3D point cloud, whereby dividing the 3D point cloud into three classes: the scattered points Cₚ, the linear points Cₗ, and the surface points Cₛ;
step 5: extracting an initial ground Gₛ; wherein, for each surface point in the set Cₛ, a normal vector thereof is put on a unit ball S, which is called a normal ball; by using a mean shift algorithm, the normal vectors of the surface points Cₛ are clustered on the normal ball S; then, the surface points are divided into several surface regions Fⱼ; finally, the initial ground Gₛ is extracted from the surface regions; and step 5 comprises the following substeps;
(a) for each surface point in Cₛ, putting its normal vector on a unit ball S, which is called the normal ball, wherein a terminal point of the normal vector is located on the surface of the normal ball S, and an initial point of the normal vector is located at the center of the normal ball S;
(b) choosing the mean shift algorithm to cluster the normal vectors of the surface points Cₛ on the normal ball S; dividing the normal vectors of the surface points Cₛ into several groups; and dividing the surface points Cₛ into several surface regions Fⱼ correspondingly, 1≤j≤m, where j is the serial number of the surface regions and m is the number of the surface regions; and
(c) for each surface region, calculating its average elevation h̅ⱼ and average normal vector n̅ⱼ; considering the surface region Fⱼ as a part of the initial ground Gₛ, if the average elevation h̅ⱼ and average normal vector n̅ⱼ meet the conditions: h̅ⱼ≤0.5m and −5°≤α̅ⱼ≤+5°, where α̅ⱼ is the included angle between the average normal vector n̅ⱼ and the vertical direction; and applying this method to each region Fⱼ whereby obtaining the initial ground Gₛ;
step 6; segmenting the initial ground; wherein, the initial ground point pₜ is the point in the initial ground Gₛ; by using the K-means algorithm, the initial ground Gₛ is divided into K ground fragments according to the distance between the initial ground point pₜ and the center point pₖ of each ground fragment; each ground fragment is denoted by LGₖ={pₖₛ=(xₖₛ,yₖₛ,zₖₛ)|1≤s≤nₖ}·1≤k≤K, where pₖₛ is the point in the ground fragment LGₖ, k is the serial number of the ground fragments, K is the number of the ground fragments, s is the serial number of the points in the ground fragment LGₖ, and nₖ is the number of the points in the ground fragment LGₖ; and step 6 comprises the following substeps;
(a) determining K points asinitial center points pₖ of the ground fragments by using the farthest point sampling method, wherein 1≤k≤K, and K is set at the beginning;
(b) calculating a distance between each initial ground point pₜ (1≤t≤nₛ) and the center point pₖ of each ground fragment, where t is the serial number of the points in the initial ground Gₛ and nₛ is the number of the points in the initial ground Gₛ, and assigning each initial ground point pₜ to its closest center point of the ground fragment;
(c) when all the initial ground points pₜ are assigned, recalculating the center point pₖ of each ground fragment according to the points pₖₛ in the ground fragment LGₖ by
$${p}_{k} = \frac{1}{{n}_{k}} {\sum }_{s = 1}^{{n}_{k}} {p}_{ks} , \qquad ( 2 )$$
where pₖ is the new center point of the ground fragment, and
(d) repeating the substeps (b)-(c) until pₖ does not change again; finally, grouping the points pₖₛ assigned to pₖ as one ground fragment, and dividing the initial ground Gₛ into K ground fragments LGₖ (1≤k≤K);
step 7; performing 2D Gaussian process regression, wherein the 2D Gaussian process regression is used to build the probabilistic model for each ground fragment LGₖ; the ground fragment LGₖ is used as the training samples to train the 2D Gaussian process regression model; the hyperparameters lₖ, σₖ² and σₙ² of the model are solved by using the conjugate gradient method; and step 7 comprises the following substeps:
(a) defining a discrete function zₖₛ=ƒ_{d}(tₖₛ), tₖₛ=[xₖₛ,yₖₛ]^{T} on the ground fragment LGₖ, wherein the value of the discrete function ƒ_{d}(tₖₛ) at a location tₖₛ represents the random variable in the Gaussian process;
(b) specifying the Gaussian process by its mean function m(tₖₛ) and covariance function k(tₖₛ, tₖₜ), tₖₛ, tₖₜ∈{tₖ₁, tₖ₂, . . . , tₖₙ_{ₖ}} as
$$\{ \begin{matrix}m ( {t}_{k s} ) = ( {f}_{d} ( {t}_{ks} ) ) \\ k ( {t}_{ks} , {t}_{kt} ) = [ ( {f}_{d} ( {t}_{ks} ) - m ( {t}_{ks} ) ) ( {f}_{d} ( {t}_{kt} ) - m ( {t}_{kt} ) ) ]\end{matrix} . \qquad ( 3 )$$
and writing Gaussian process as ƒ_{d}(tₖₛ)˜ [symbol] (m(tₖₛ), k(tₖₛ, tₖₜ));
(c) in consideration of the noise ε, changing the discrete function is to zₖₛ=ƒ_{d}(tₖₛ)+ε; assuming additive identically distributed independent Gaussian noise ε with the variance σₙ²; and obtaining the joint prior distribution of the observed values zₖ=[zₖ₁, zₖ₂, . . . , zₖₙ_{ₖ}]^{T} as
zₖ˜N(0,K(Tₖ,Tₖ)+σₙ²I) (4),
where Tₖ=[tₖ₁, tₖ₂, . . . , tₖₙ_{ₖ}] and K(Tₖ,Tₖ)=(kₛₜ) is a nₖ×nₖ covariance matrix of the training inputs Tₖ; the element kₛₜ is used to measure the correlation between tₖₛ and tₖₗ, and kₛₜ is the squared exponential covariance function, which has the following form
$${k}_{st} = {σ}_{k}^{2} exp \{ - \frac{1}{2 {l}_{k}^{2}} {\vert {t}_{k s} - {t}_{kt} \vert}^{2} \} , \qquad ( 5 )$$
where lₖ is the length-scale, σₖ² is the signal variance, and 1≤s, t≤nₖ(s≠t);
(d) giving the joint prior distribution of the observed values zₖ and the predicted value ƒ_{*} at the test location t_{*}=[x_{*},y_{*}]^{T} by
$$[ \begin{matrix}{z}_{k} \\ {f}_{*}\end{matrix} ] ∼ N ( 0 , [ \begin{matrix}K ( {T}_{k} , {T}_{k} ) + {σ}_{n}^{2} I & K ( {T}_{k} , {t}_{*} ) \\ K ( {t}_{*} , {T}_{k} ) & K ( {t}_{*} , {t}_{*} )\end{matrix} ] ) , \qquad ( 6 )$$
where K(Tₖ,t_{*})=K(t_{*},Tₖ)^{T} is the nₖ×1 covariance matrix of the training inputs Tₖ and the test input t_{*}, K(t_{*},t_{*}) is the covariance of the test input t_{*}, and I is the nₖ×nₖ unit matrix; and giving the posterior distribution of the predicted value ƒ_{*}, namely the 2D Gaussian process regression model of the ground fragment LGₖ, by
ƒ_{*}|Tₖ,zₖ,t_{*}˜N(m(ƒ_{*}),cov(ƒ_{*})) (7),
where
m(ƒ_{*})=K(t_{*},Tₖ)[K(Tₖ,Tₖ)+σₙ²I]⁻¹zₖ (8),
cov(ƒ_{*})=K(t_{*},t_{*})−K(t_{*},Tₖ)[K(Tₖ,Tₖ)+σₙ²I]⁻¹K(Tₖ,t_{*}) (9),
m(ƒ_{*}) and cov(ƒ_{*}) are the mean and variance of ƒ_{*} at the test location t_{*}; and
(e) using the points in the ground fragment LGₖ as the training samples, establishing the negative logarithm likelihood function of the conditional probability of the training samples; calculating the partial derivatives of the hyperparameters lₖ, σₖ² and σₙ²; and using the conjugate gradient method to minimize the partial derivatives to obtain the optimal solution of the hyperparameters;
step 8: finding the neighborhood of each ground fragment LGₖ; wherein for each ground fragment LGₖ, a distance between each point pₖₛ (pₖₛ∈LGₖ) in the ground fragment LGₖ and each point pₐ in the 3D point cloud P={pₐ=(xₐ, yₐ, zₐ)|1≤a≤nₐ} of the outdoor scene is computed; if the distance is less than the threshold rₖ, pₐ is regarded as a neighboring point of the ground fragment LGₖ, where a is the serial number of the points in the 3D point cloud P of the outdoor scene and nₐ is the number of the points in the 3D point cloud P of the outdoor scene, and step 8 comprises the following substeps:
(a) computing the neighborhood Nₚ_{ₖₛ}={pₖₛ^{b}|1≤b≤nₖₛ, pₖₛ^{b}∈P, |pₖₛ^{b}−pₖₛ|≤rₖ} of each points pₖₛ in the ground fragment LGₖ, where nₖₛ is the number of the neighboring points of pₖₛ, rₖ=0.25\sqrt{nₖ}dₖ, dₖ=Σₛ₌₁ⁿ^{ₖ}|pₖₛ−p̅ₖₛ|/nₖ, and p̅ₖₛ is the closest point to pₖₛ; and
(b) composing, by all the neighborhoods Nₚ_{ₖₛ}, the neighborhood N_{LG}_{ₖ} of the ground fragment LGₖ; and letting N_{LG}_{ₖ}={\hat{p}_{ks′}=(\hat{x}_{ks′},ŷ_{ks′},\hat{z}_{ks′})|1≤s′≤\hat{n}ₖ}, where \hat{p}_{ks′} is the neighboring point of the ground fragment LGₖ, s′ is the serial number of the neighboring points, and \hat{n}ₖ is the number of the neighboring points; and
step 9: extracting the final ground Gₑ; wherein the neighborhood N_{LG}_{ₖ} of each ground fragment LGₖ is substituted into the 2D Gaussian process regression model of the ground fragment LGₖ; for each point \hat{p}_{ks′}∈N_{LG}_{ₖ}, the predicted mean m(\hat{ƒ}_{ks′}) and variance cov(\hat{ƒ}_{ks′}) at the test location \hat{t}_{ks′}=[\hat{x}_{ks′},ŷ_{ks′}]^{T} are calculated, if they meet the conditions: cov(\hat{ƒ}_{ks′})≤σ̅² and |m(\hat{ƒ}_{ks′})−\hat{z}_{ks′}|/\sqrt{σₖ²+σₙ²}≤d̅, where σ̅²=0.05 is the threshold of the variance and d̅=0.2 is the threshold of the Mahalanobis distance, the point \hat{p}_{ks′} is regarded as a ground point; by using this method for each ground fragment LGₖ to check the points in its neighborhood, the ground points in the neighborhood N_{LG}_{ₖ} of each ground fragment LGₖ is found; then, the final ground Gₑ is obtained.
